(19) United States
(12) Patent Application Publication
(10) Pub. No.: US 2013/0275320 A1
(43) Pub. Date: Oct. 17, 2013

(54) Identifying Prospective Employee Candidates via Employee Connections

(71) Applicants: Matthew Aaron Moore, San Francisco, CA (US); Sunil Chandra, San Francisco, CA (US); Geordon Kitchen, San Francisco, CA (US)

(72) Inventors: Matthew Aaron Moore, San Francisco, CA (US); Sunil Chandra, San Francisco, CA (US); Geordon Kitchen, San Francisco, CA (US)

(73) Assignee: GOOGLE INC., Mountain View, CA (US)

(21) Appl. No.: 13/448,231

(22) Filed: Apr. 16, 2012

(51) Int. Cl. G06Q 10/06

(52) U.S. Cl. 705/321

(57) ABSTRACT

Various implementations for identifying prospective employee candidates via employee connections are disclosed. In some implementations, a system includes an employee identification module, a candidate identification module, and an interface module. The employee identification module identifies at least one first user as an employee of an employer based at least in part on employer information. The candidate identification module identifies at least one second user as a prospective employee candidate based at least in part on social graph connection information including at least a social graph connection between the first user and the second user. The interface module generates a summary of the second user as the prospective employee candidate and provides the summary for display to a third user. The interface module is coupled to a communication unit to provide the summary for display to the third user.

### BACKGROUND

The present disclosure relates to electronic communication. In particular, the present disclosure relates to identifying prospective employee candidates via employee connections.

To recruit new employees, businesses often implement internal employee referral programs. In some cases, these programs offer employees financial incentives to refer potential employee candidates from their own professional networks. However, these programs can be costly to operate and may require employees to allocate time and resources to find and interact with the potential candidates, which can reduce their productivity at work.

### SUMMARY

The present disclosure overcomes the deficiencies and limitations discussed in the Background section at least in part by providing systems and methods for conveniently identifying prospective employee candidates via employee connections. In one innovative aspect, a system includes an employee identification module, a candidate identification module, and an interface module. The employee identification module identifies at least one first user as an employee of an employer based at least in part on employer information. The candidate identification module identifies at least one second user as a prospective employee candidate based at least in part on social graph connection information including at least a social graph connection between the first user and the second user. The candidate identification module is coupled to the employee identification module or an information source to receive information describing the second user. The interface module generates a summary of the second user as the prospective employee candidate and provides the summary for display to a third user. The interface module is coupled to a communication unit to provide the summary for display to the third user.

In another innovative aspect, a computer-implemented method includes receiving, using one or more computing devices, social graph connection information. The social graph connection information includes at least a social graph connection between a first user and a second user. Further, using the one or more computing devices, the method includes receiving employer information for an employer; receiving a request for a prospective employee candidate for the employer from a third user; identifying the first user as an employee of the employer based at least in part on the employer information; identifying the second user as a prospective employee candidate based at least in part on the social graph connection between the first user and the second user; generating a summary of the second user as the prospective employee candidate; and providing the summary for presentation to the third user.

Other aspects include corresponding systems, methods, and apparatus, including computer program products.

The implementations described herein are particularly advantageous in a number of respects. For instance, they can automatically identify suitable employee candidates who have connections to a given employer by performing a simple search; they can identify which employee or employees a given candidate is connected to, and how they are connected, which is advantageous as the employer can initially identify the candidate without involving the employee, and once identified, can then confer with the employee, for example, via the social network about the candidate or can then engage the candidate directly, for example, via the social network; they can refine and rank the candidates to surface the most suitable candidates for an employment position; etc. It should be understood that this list of features and advantages is provided by way of example and is not all-inclusive, as many additional features and advantages fall within the scope of the present disclosure. Moreover, it should be noted that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for identifying prospective employee candidates via employee connections.

FIG. 2A is a block diagram of an example social network server.

FIG. 2B is a block diagram of an example prospective candidate identification engine.

FIG. 3 is a flowchart of an example method for identifying prospective employee candidates via employee connections.

FIGS. 4A-B are flowcharts of another example method for identifying prospective employee candidates via employee connections.

FIGS. 5A-B are flowcharts of yet another example method for identifying prospective employee candidates via employee connections.

FIG. 6 is a graphic representation of an example user interface for displaying prospective employee candidates identified via employee connections.

### DETAILED DESCRIPTION

### Overview

An example system and method for identifying prospective employee candidates via employee connections are described below. The example system includes an employee identification module for identifying at least one first user as an employee of an employer based on employer information. In some embodiments, the user is identified as an employee by querying an information source for a user profile that matches the employer information. For example, the user profile of the user includes professional information that identifies the user as an employee of the employer. A candidate identification module then identifies at least one second user as a prospective employee candidate based on social graph connection information including at least a social graph connection between the first user and the second user. In some embodiments, the second user is identified as a prospective employee candidate based at least in part on an employment criterion. For example, the employment criterion is an employment-related attribute such as a user's work experience, and the user profile of the second user includes information that matches the attribute.

The example system includes an interface module for generating and providing a summary of the second user as the prospective employee candidate. In some embodiments, the candidate identification module identifies a plurality of second users as prospective employee candidates based on social graph connections between the first user and the second users. These second users may be ranked by a ranking module of the system based on a ranking criterion. For example, the second users may be ranked based on their work experience. In another example, the second users may be ranked using a score generated by the ranking module for each second user. In some embodiments, the summary may be generated to reflect the ranking of the second users as prospective employee candidates.

### System Overview

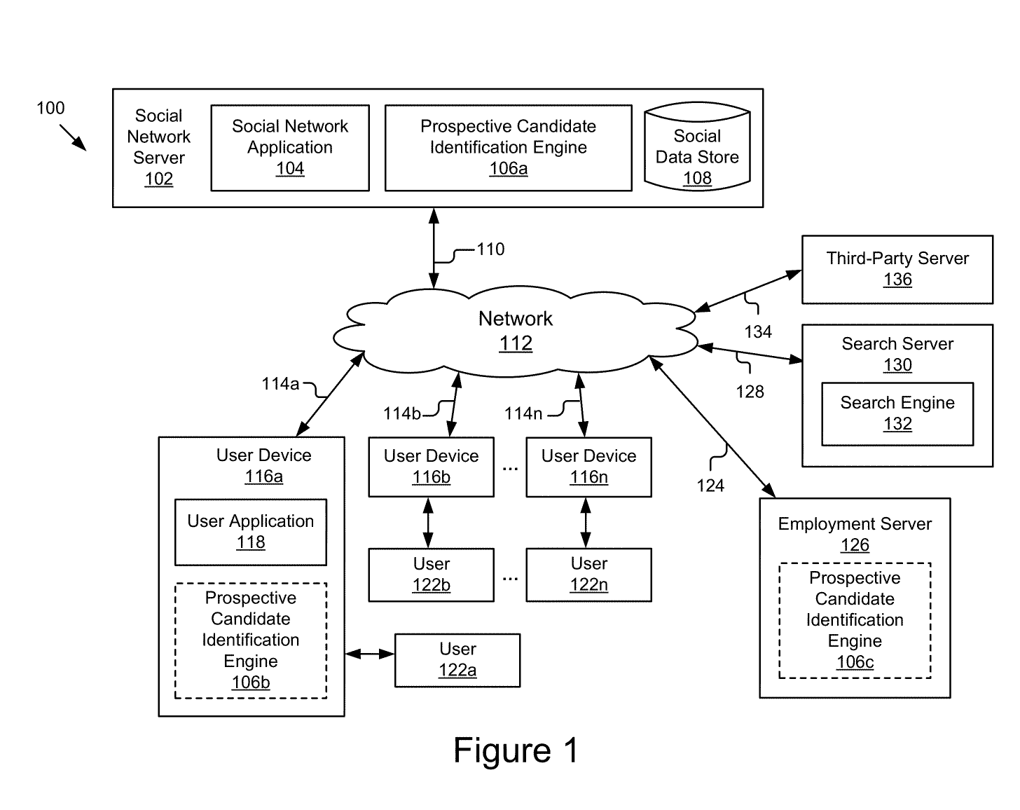

FIG. 1 is a block diagram illustrating an example system 100 for identifying prospective employee candidates via employee connections. The illustrated system 100 includes a social network server 102, a network 112, one or more client/user devices 116a, 116b . . . 116n (also referred to herein individually and collectively as 116) that are accessible by users 122a, 122b . . . 122n (also referred to herein individually and collectively as 122), an employment server 126, a search server 130, and a third-party server 136. In the illustrated embodiment, the entities 102, 116a . . . 116n, 126, 130, and 136 are electronically communicatively coupled via the network 112. However, the present disclosure is not limited to this configuration and the entities of system 100 may be connected to and/or interconnected by any number of networks. Further, while the present disclosure is described above primarily in the context of activities related to identifying prospective employee candidates, the present disclosure is applicable to identifying any type or class of users.

In the depicted embodiment, the social network server 102 is coupled to the network 112 via signal line 110, and interacts with the other entities 116, 126, 130, and 136 of the system 100 via the network 112. In some embodiments, the social network server 102 includes one or more processors and one or more storage devices storing data or instructions for execution by the one or more processors. For example, the social network server 102 is a server, a server array or any other computing device, or group of computing devices, having data processing, storing, and communication capabilities. In other embodiments, the social network server 102 is a virtual server (i.e., a virtual machine) implemented via software. For example, the virtual server operates in a host server environment and accesses the physical hardware of the host server including, for example, a processor, memory, storage, network interfaces, etc., via an abstraction layer (e.g., a virtual machine manager). In these or other embodiments, the social network server 102 may be implemented using a cloud-based architecture, with its software components operating as a service on one or more servers distributed through the network 112. It should be understood that the social network server 102 can be stored in any combination of devices and servers, or in only one of the devices or servers. Although only one social network server 102 is shown, multiple social network servers 102 may be included in the system 100.

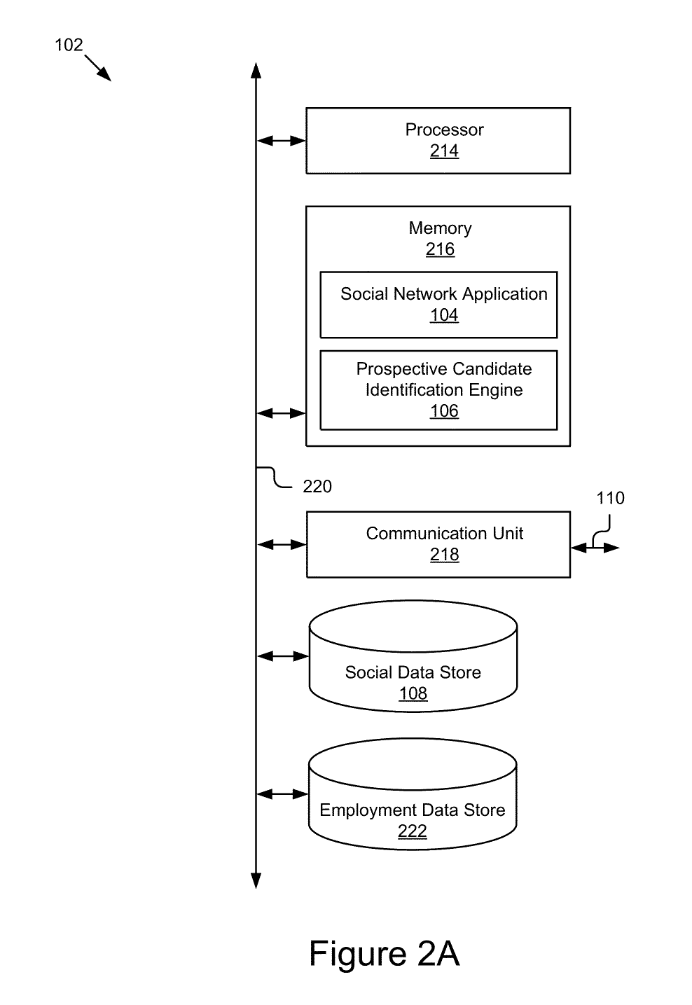

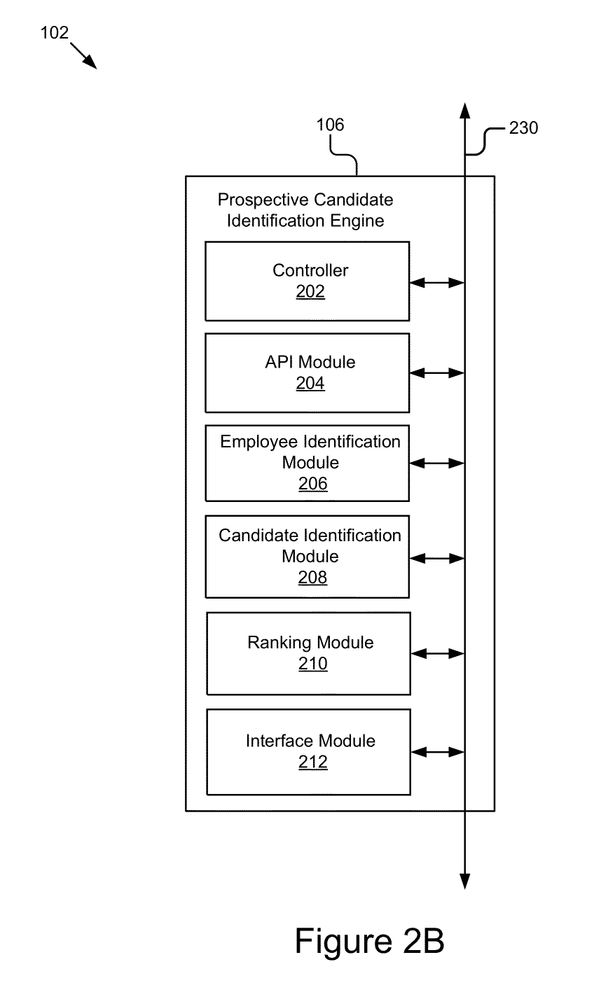

In the depicted embodiment, the social network server 102 includes a social network application 104, a prospective candidate identification engine 106a (also referred to herein individually and collectively as 106), and a social data store 108. The social network application 104 is software including routines for providing functionality for a social network. The prospective candidate identification engine 106 is software including routines for identifying one or more prospective employee candidates via the connections of an employer's employees. Additional structure and functionality of the social network application 104, the prospective candidate identification engine 106, and the social data store 108 are further described below with reference to at least FIG. 2.

In some embodiments, the prospective candidate identification engine 106 is included in and operable on the social network server 102. In other embodiments, the prospective candidate identification engine 106 may be included in and operable on the employment server 126 or a user device 116. Instances 106b and 106c of the prospective candidate identification engine 106 are depicted in FIG. 1 as respectively included in the client device 116a and the employment server 126 in addition to or in the place of being included in the social network server 102.

The user devices 116a, 116b . . . 116n are computing devices having data processing and data communication capabilities. In some embodiments, the user device 116 is a handheld wireless computing device which is capable of sending and receiving voice and/or data communications. For example, the user device 116 may include a processor, a memory, a power source and one or more network interfaces coupled via a data bus, where the one or more network interfaces broadcast and receive control data, voice data, and/or network data via radio signals.

The user devices 116 may include one or more wired or wireless network interfaces for sending and receiving network data; a graphics processor; a high-resolution touchscreen; a physical keyboard; forward and rear facing cameras; sensors such as accelerometers and/or gyroscopes; a GPS receiver; a Bluetooth module; memory storing applicable firmware; and various physical connection interfaces (e.g., USB, HDMI, headset jack, etc.); etc. Additionally, an operating system for managing the hardware and resources of the user device 116, application programming interfaces (APIs) for providing applications access to the hardware and resources, a user interface module for generating and displaying interfaces for user interaction and input, and applications such as applications for making phone calls, video calls, web browsing, messaging, social networking, gaming, capturing digital video and/or images, etc., may be stored and operable on the user device 116. In some embodiments, a user device 116 is a computing device such as a workstation computer, a desktop computer, a laptop computer, a netbook computer, a tablet computer, a smartphone, a set-top box/unit, a television with one or more processors embedded therein or coupled thereto and capable of receiving viewer input, accessing video content on computer networks such as the Internet, and executing software routines to provide enhanced functionality and interactivity to viewers, or the like. In other embodiments, different user devices 116a, 116b . . . 116n comprise different types of computing devices. For example, the user device 116a is a laptop, the user device 116b is a tablet computer, and the user device 116n is a smartphone. In some embodiments, the user device 116 is a client or terminal device.

The user devices 116a, 116b . . . 116n in FIG. 1 are included by way of example. While FIG. 1 illustrates three or more user devices, the present disclosure applies to any system architecture having one or more user devices. The user device 116a is coupled to the network 112 via signal line 114a and the user 122a interacts with the user device 116a. The user devices 116b and 116n are coupled to the network 112 via signal lines 114b and 114n, respectively, and the users 122b and 122n interact with the user devices 116b and 116n, respectively.

In the depicted embodiment, the user device 116a contains a user application 118 executable by a processor (not shown) of the user device 116 to provide for user interaction, and to send and receive data via the network 112. In particular, the user application 118 is operable to instruct the user device 116 to render user interfaces, receive user input, and send information to and receive information from the prospective candidate identification engine 106a or 106b. While in the depicted embodiment, just the user device 116a is depicted as including the user application 118, any number of user devices 116 may include an instance of the user application 118. In some embodiments, the user application 118 is client code operable in a web browser. In these or other embodiments, the user application 118 is stored in a memory (not shown) of the user device 116a and is accessible and executable by a processor (not shown).

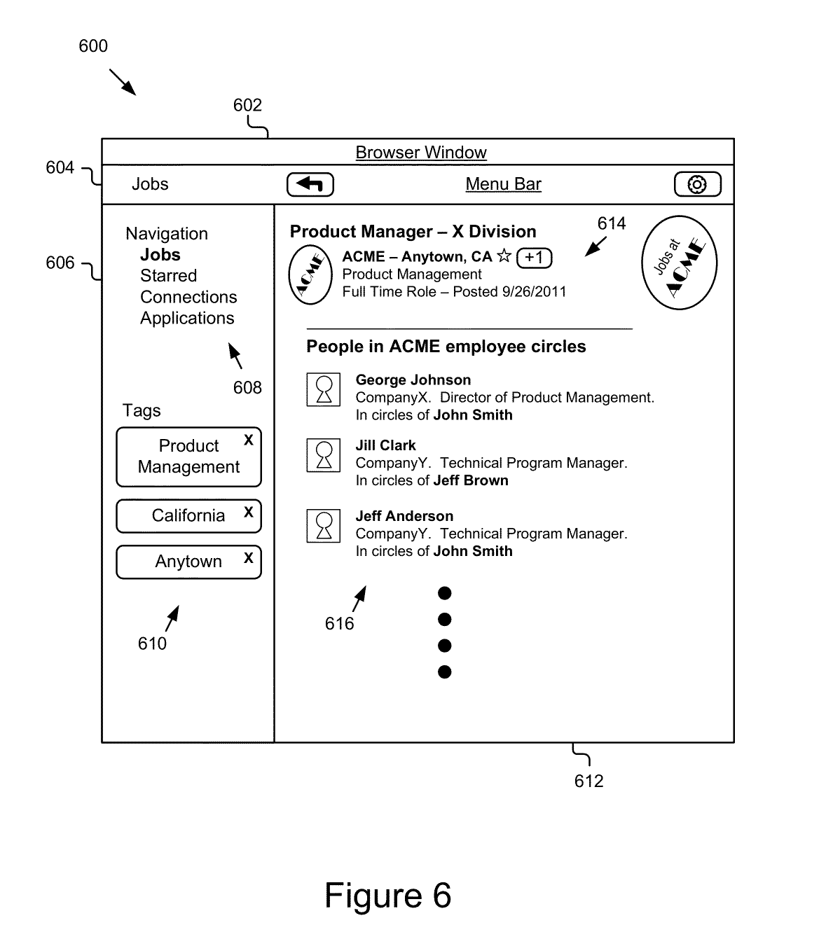

In some embodiments, the user application 118 generates and presents user interfaces to the user 122a via a display (not shown). For example, the user application 118 may generate and present the user interface 600 depicted in FIG. 6 based at least in part on information received from the prospective candidate identification engine 106a, 106b, and or 106c, via the network 112. In some embodiments, the user application 118 is code operable in a browser launched on the user device 116a, the browser receives interface instructions from the prospective candidate identification engine 106a of the social network server 102 via the network 112 in the form of a mark-up language (e.g., HTML, XML, etc.), style sheets (e.g., CSS, XSL, etc.), graphics, and/or scripts (e.g., JavaScript, ActionScript, etc.), and the browser interprets the interface instructions and renders an interactive Web User Interface (WUI) for display on the user device 116a based thereon. In other embodiments, some or all of the interface instructions are provided by the user application 118 while the employment-related information is provided by the prospective candidate identification engine 106. Other variations are also contemplated and within the scope of this disclosure. The user application 118 is also operable to receive input signals from the user 122a via an input device (not shown) of the user device 116a, and to send information to the prospective candidate identification engine 106 via a communication unit (not shown) coupled to the network 112, such as one like or substantially similar to the communication unit 218.

The network 112 includes one or more wired or wireless networks and may have any number of configurations such as a star configuration, token ring configuration or other known configurations. The network 112 may include a local area network (LAN), a wide area network (WAN) (e.g., the Internet), and/or any other interconnected data path across which multiple devices may communicate. The network 112 may be coupled to or include mobile (cellular) networks including distributed radio networks and a hub providing a wireless wide area network (WWAN), or other telecommunications networks. In some embodiments, the network 112 may include Bluetooth communication networks for sending and receiving data. The network 112 may transmit data using a variety of different communication protocols including user datagram protocol (UDP), transmission control protocol (TCP), hypertext transfer protocol (HTTP), hypertext transfer protocol secure (HTTPS), file transfer protocol (FTP), direct data connection, wireless access protocol (WAP), various email protocols, etc. User devices 116 may couple to and communicate via the network 112 using a wireless and/or wired connection. In some embodiments, the communication unit (not shown) of the user devices 116 include a wireless network interface controller for sending and receiving data packets to an access point of the network 112. For example, the user devices 116 may be Wi-Fi enabled devices which connect to wireless local area networks (WLANs), such as wireless hotspots. The user devices 116 may also include one or more wireless mobile network interface controllers for sending and receiving data packets via a WWAN of the network 112.

The employment server 126 is a computing device or system for providing an online employment service. The employment service may include a network-based software application providing functionality to users 122 to search for electronic job listings stored in a job database, post resumes, provide employment advice to job seekers and employers interested in hiring qualified candidates, communicate with other users, search for prospective candidates, etc. In some implementations, the employment server 126 may include an instance of the prospective candidate identification engine 106a to provide the functionality discussed in further detail below with reference to at least FIGS. 2-6.

In some embodiments, the employment server 126 is a server, server array or any other computing device, or group of computing devices, having data processing, storing and communication capabilities. In these or other embodiments, the third-party server may include one or more computing device having the same or similar architecture as that described with reference to FIG. 2. For simplicity, a single block for the employment server 126 is shown. However, in other embodiments, several distinct employment servers (not shown) may be coupled to the network via distinct signal lines to provide distinct or competing employment services.

In the depicted embodiment, the employment server 126 is coupled to the network 112 via signal line 124 for interaction with the social network server 102, the user devices 116a, 116b . . . 116n, and any other entity or entities coupled to the network 112. In some implementations, the employment server 126 may send data to and receive data from the social network application 104, the prospective candidate identification engine 106a, and/or the social data store 108. For example, the employment server 126 may access social graph and user profile data from the social data store 108 via the network 112 using an API.

In the depicted embodiment, the search server 130 is communicatively coupled to the network 112 via signal line 128, and includes a search engine 132 for retrieving results that match search terms from the Internet. The search server 130 may be a server, server array or any other computing device, or group of computing devices, having data processing, storing, and communication capabilities. The other entities of the system 100 may interact with the search engine 132 via the network 112 to retrieve the results matching various search terms provided to the search engine 132. For example, the prospective candidate identification engine 106 may signal the search engine 132 to provide search results matching a particular prospective candidate's name. In some embodiments, the search results may be filtered by the search engine 132 to include a particular type of information, for example, academic or profession-related information. For example, the search results provided by the search engine 132 for a particular candidate may include academic or professional publications authored by that candidate. Although, only one search server 130 is shown, it should be understood that multiple search servers 130 may be included in the system 100.

The third-party server 136 is a computing device or system for providing various computing functionalities, services, and/or resources to the other entities of the system 100. In the depicted embodiment, the third-party server 136 is communicatively coupled to the network 112 via signal line 134 for communication with the other components of the system 100. In some implementations, the third-party server 136 is a server hosting a network-based software application operable to provide the computing functionalities, services, and/or resources, and to send data to and receive data from the other entities of the network 112. For example, the third-party server 136 may operate a software application for user account management, internet searching; social networking; web-based email; blogging; micro-blogging; photo management; video, music and multimedia hosting, distribution, and sharing; business services; news and media distribution; or any combination of the foregoing services. It should be understood that the third-party server 136 is not limited to providing the above-noted services and may include any other network-based or cloud-based service.

For simplicity, a single block for the third-party server 136 is shown in FIG. 1. However, in this or other implementations, several distinct third-party servers (not shown) may be coupled to the network via distinct signal lines which operate applications providing distinct or competing functionalities and/or resources. Similar to the social network application 104, the employment server 126 and/or the third-party server 136 may require users 122 to be registered to use various functionality respectively provided by the employment server 126 and/or the third-party server 136. Accordingly, the below description for registering and authenticating a user discussed with reference to the social network application 104 is applicable to the employment server 126 and/or the third-party server 136. However, in the interest of brevity, that description will not be repeated here.

### Social Network Server 102

FIG. 2A is a block diagram of an example social network server 102. In the depicted embodiment, the social network server 102 is a computing device comprising a social data store 108, a processor 214, a memory 216, a communication unit 218, and an employment data store 222. The components 108, 214, 216, 218, and 222 are communicatively coupled via a communication bus 220. The bus 220 can be any type of conventional communication bus for transferring data between components of a computer, or between computers.

The processor 214 includes an arithmetic logic unit, a microprocessor, a general purpose controller, or some other processor array to perform computations and provide electronic display signals to a display device (not shown). The processor 214 may be coupled to the bus 220 for communication with the other components of the social network server 102. The processor 214 may process data signals and may have various computing architectures including a complex instruction set computer (CISC) architecture, a reduced instruction set computer (RISC) architecture, or an architecture implementing a combination of instruction sets. Although only a single processor 214 is shown in FIG. 2, multiple processors may be included. The processor 214 may be capable of supporting the display of images and the capture and transmission of images, perform complex tasks, including various types of feature extraction and sampling, etc. It should be understood that the social network server 102 may include various operating systems, sensors, displays, additional processors, and other physical configurations.

The memory 216 stores instructions and/or data that may be executed by the processor 214. In the depicted embodiment, the memory 216 stores at least the social network application 104 and the prospective candidate identification engine 106. The memory 216 is also capable of storing other instructions and data such as an operating system, hardware drivers, other software applications, databases, etc. The memory 216 is coupled to the bus 220 for communication with the processor 214 and the other components of social network server 102. The instructions and/or data may comprise code for performing any and/or all of the techniques described herein. In particular, the memory 216 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 214. A non-transitory computer-usable storage medium may include any and/or all computer-usable storage media. In some implementations, the memory 216 may include volatile memory, non-volatile memory, or both. For example, the memory 216 may include a dynamic random access memory (DRAM) device, a static random access memory (SRAM) device, flash memory, a hard disk drive, a floppy disk drive, a CD ROM device, a DVD ROM device, a DVD RAM device, a DVD RW device, a flash memory device, or any other mass storage device known for storing information on a more permanent basis. It should be understood that the memory 216 may be a single device or may include multiple types of devices and configurations.

The communication unit 218 is coupled to the network 112 by the signal line 110 and coupled to the bus 220. In some embodiments, the communication unit 218 is a network interface device (I/F) which includes ports for wired connectivity. For example, the communication unit 218 includes a CAT-5 interface, USB interface, or SD interface, etc. The communication unit 218 links the processor 214 to the network 112 that may in turn be coupled to other processing systems. The communication unit 218 provides other connections to the network 112 and to other entities of the system 100 using standard communication protocols including, for example, TCP/IP, HTTP, HTTPS, etc. In other embodiments, the communication unit 218 includes a transceiver for sending and receiving signals using Wi-Fi, Bluetooth® or cellular communications for wireless communication.

A social network is any type of social structure where the users are connected by one or more common features. The common features include relationships/connections, e.g., professional, academic, friendship, family, an interest, etc. The common features are provided by one or more social networking systems, such as those included in the system 100. The common features include explicitly-defined relationships and relationships implied by social connections with other online users and entities. Each individual user's relationships with other users and entities, explicit or implicit, form a social graph for that user. For example, a user's social graph may include social graph connection information describing one or more sets formed by that user to categorize or group his or her connections on the social network, the strength of the connections between the user and other users (i.e., the degree or degrees (e.g., 1st, 2nd, 3rd, 4th, etc.) of separation between the user and other users, and who, if any, the connecting/interstitial users are), what attributes, interests, social network activity, etc., connect the user to other users, etc. For instance, a user may define, via an interface provided by the social network application 104, sets for users who are work friends, school friends, networking contacts, clients, etc., and user's the social graph may include data reflecting what sets these users belong to. Collectively, the social graphs can reflect a mapping of these users and how they are related. In some embodiments, the social graphs are stored in the social data store 108.

The social data store 108 is an information source for storing and providing user-related information, such as, the social graph of each user of the social network application 104, a profile of each user, each user's social network activity including, for example, social stream posts, notifications sent and received, comments, positive or negative endorsements for various content posted by other users, etc. A user's profile may include the user's personal and professional information. Professional information may describe a user's career/occupational information, such as work experience, education, etc. In particular, the professional information may include professional-related attributes such as a user's professional experience and qualifications, such as the user's employment history including employers the user has worked for and is currently employed by, the user's job title, skills and certifications acquired by the user, honors and awards received by the user, which educational institutions the user attended or is attending, what degrees the user has obtained or is working on, the user's GPA, academic or professional publications authored or contributed to by the user, any assessment by other users of the user's professional or educational performance, etc.

In the depicted embodiment, the social data store 108 is coupled for communication with the components 202, 204, 206, 208, 210, and 212 of the prospective candidate identification engine 106 and the other components 104, 214, 216, 218 and 222 of the social network server 102 via the bus 220. In some embodiments, the social data store 108 is coupled to the controller 202, the API module 204, the employee identification module 206, the candidate identification module 208, the ranking module 210, and the interface module 212, so these modules can manipulate, i.e., store, query, update and/or delete data stored in the social data store 108 using programmatic operations.

In some embodiments, the social data store 108 may be included in the memory 216. In other embodiments, the social data store 108 may be included in a separate computing or memory device. In some embodiments, the social data store 108 may include a database management system (DBMS) operable on the social network server 102. For example, the DBMS could be a structured query language (SQL) DBMS. In these embodiments, the social network server 102, and in particular, the prospective candidate identification engine 106 are coupled to the DBMS in cooperation with the processor 214 and, in some cases, the network 112 to store data in an object-based datastore or multi-dimensional tables comprised of rows and columns, and manipulate, i.e., insert, query, update and/or delete, data entries stored in the social data store 108 using programmatic operations (e.g., SQL queries and statements or a similar database manipulation library).

Functionality for the social network is provided by the social network application 104. In some embodiments, the social network application 104 is a set of instructions executable by the processor 214 for providing the functionality for the social network. In other embodiments, the social network application 104 is stored in the memory 216 of the social network server 102 and is executable by the processor 214 to provide this functionality. In any of these embodiments, the social network application 104 is adapted for cooperation and communication with the processor 214 and the other components of the social network server 102.

It should be understood that the social network server 102, the social data store 108, and the social network application 104 are representative of one social network and that there may be multiple social networks coupled to the network 112, each having its own server, application, and social graph. For example, a first social network is more directed to business networking, a second more directed to or centered on academics, a third more directed to local business, a fourth directed to dating and others of general interest or a specific focus. In some embodiments, the social data store 108 is included in the social network server 102 as depicted in FIG. 2. In other embodiments, the social data store 108 is coupled to the network 112 and includes a virtual server or server hardware having a data repository for managing the data describing the social graphs of the users of various social networks including the social network represented by the social network server 102 and the social network application 104.

The social network application 104 and/or the prospective candidate identification engine 106 may require users 122 to be registered to use various functionalities. In some embodiments, to register with the social network application 104, the application may require a user to provide identifying information, for example, a valid electronic mail address and password, and the application may test the validity of the electronic mail address by sending the a confirmation message to the address containing instructions for confirming the account (e.g., selecting a hyperlink to a confirmation webpage operated by the service provider). In other embodiments, the social network application 104 may interact with a federated identity server (not shown) to register/authenticate users. Once registered, the social network application 104 may require a user seeking access to authenticate by inputting the identifying information in an associated user interface.

The employment data store 222 is an information source for storing and providing access to data. In some embodiments, the employment data store 22 is included in the memory 216. In other embodiments, the employment data store 222 is included in a separate memory device or computing device. The data store by the employment data store 222 includes information generated, received, or sent by the controller 202, the API module 204, the employee identification module 206, the candidate identification module 208, the ranking module 210, and the interface module 212. For example, the employment data store 222 may store a log of any search requests for prospective employee candidates, queries for employees by the employee identification module 206, queries for prospective employee candidates by the candidate identification module 208, the results produced by those queries, the users whose profiles were selected and viewed from among the results, the rankings and scores generated by the ranking module 210, etc. In some embodiments, the employment data store 222 may store/update metadata for users that repeatedly show up as top-ranked prospective candidates across multiple queries, and the candidate identification module 208 and the ranking module 210 may respectively use this metadata when identifying and ranking prospective candidates. In some embodiments, the employment data store 222 includes a local repository of social graph and profile data retrieved from the social data store 108. In the depicted embodiment, the employment data store 222 is coupled for communication with the components 202, 204, 206, 208, 210, and 212 of the prospective candidate identification engine 106 and the other components 104, 108, 214, 216, and 218 of the social network server 102 via the bus 220. In some embodiments, the employment data store 222 is a database or DMBS, as discussed above with reference to the social data store 108.

### The Prospective Candidate Identification Engine 106

The prospective candidate identification engine 106 is software including routines for identifying prospective employee candidates via employee connections. A prospective employee candidate is an individual that an employer could possibly hire as an employee. The prospective candidate identification engine 106 can search for the employees of an employer, and once the employees are identified, can query the social graph of each employee for the users connected to that employee that could be hired by the employer. These users are referred to as prospective employee candidates. The prospective candidate identification engine 106 may filter the initial set of candidates produced by the query using employment criteria, rank the candidates, and generate and provide a summary of the candidates for display.

The prospective candidate identification engine 106 may interact with one or more instances of the user application 118 respectively operating on one or more user devices 116 coupled to the network 112 to send and receive employment-related information. For example, a user 116a (e.g., a recruiter) searching on behalf on an employer may transmit a search request via the user application 118 to the prospective candidate identification engine 106 via the network 112. Responsive to receiving the request, the prospective candidate identification engine 106 may identify the most suitable prospective employee candidates from the social graphs of the employees of the employer.

In some embodiments, the prospective candidate identification engine 106 is a set of instructions executable by the processor 214 to provide its functionality. In other embodiments, the prospective candidate identification engine 106 is stored in the memory 216 of the social network server 102 and is accessible and executable by the processor 214 to provide this functionality. In any of these embodiments, the prospective candidate identification engine 106 is adapted for cooperation and communication with the processor 214 and the other components of the social network server 102.

In some embodiments, such as the example embodiment depicted in FIG. 2A, the prospective candidate identification engine 106 may interact and communicate with the social network application 104 and the social data store 108. In these or other embodiments, the prospective candidate identification engine 106 may be stored and operable on the employment server 126 and/or a user device 116, which is coupled by the network 112 for communication and interaction with the social network server 102, the social network application 104 and the social data store 108.

As depicted in FIG. 2B, the prospective candidate identification engine 106 may include a controller 202, an API module 204, an employee identification module 206, a candidate identification module 208, a ranking module 210, and an interface module 212 that communicate over a software communication mechanism 230. The software communication mechanism 230 may be an object bus (such as CORBA), direct socket communication (such as TCP/IP sockets) among software modules, remote procedure calls, UDP broadcasts and receipts, HTTP connections, function or procedure calls, etc. Further, any or all of the communication could be secure (SSH, HTTPS, etc). The software communication can be implemented on any underlying hardware, such as a network, the Internet, a bus 220, a combination thereof, etc.

The controller 202 is software including routines for handling requests received from another entity of the system 110. In some embodiments, the controller 202 is a set of instructions executable by the processor 214 to provide this functionality. In other embodiments, the controller 202 is stored in the memory 216 of the social network server 102 and is accessible and executable by the processor 214 to provide this functionality. In any of these embodiments, the controller 202 is adapted for cooperation and communication with the processor 214 and the other components of the social network server 102.

In the depicted embodiment, the controller 202 is coupled to the network 112 via the communication unit 218 to receive a search request. In some embodiments, the search request may be generated by and received from a user device 116. In other embodiments, the search request may be generated by and received from another entity of the system 100, or may be automatically generated by the social network server 102. A search request may include a request for the prospective candidate identification engine 106 to identify prospective employee candidates. The search request may also include search parameters such as data identifying the employer and one or more employment criteria. An employment criterion may be any employment-related attribute including, for example, number or strength of connections, location, proximity to a location (i.e., geographical area), years of experience, area of expertise, education, academic degree, title, skillset, certification, accreditation, community involvement, activity in field, substance of publications, etc. For example, a candidate having particular area of expertise and/or skillset may be desired and the search request may specify that area of expertise and/or skillset.

Responsive to receiving a search request, the controller 202 may parse the request for any parameters, such as employer information, employment criteria, the user submitting the request, etc. For example, the search request may be an HTTP GET or POST request including a URL and one or more parameters, and the controller 202 may parse the URL, the parameters, and other header information from the request and stores it in the memory 216 for later access by the controller 202 and the other components 204, 206, 208, 210, and 212. The controller 202 may additionally or alternatively query an information source for information such as employer information, predefined parameters, predefined search criteria, etc., related to the search request. For instance, the user 122 submitting the search request may be a head hunter, a human resources employee working for the employer, an employee of the employer searching for a referral candidate, etc., and the controller 202 may associate the user 122 with the employer by accessing a user account record stored in the employment data store 222 for the user 122. In some embodiments, this association could occur when the user 122 is required by the controller 202 to login to use the functionality of the prospective candidate identification engine 106 or at the time the search request is received.

The controller 202 may store any information associated with or parsed from a search request in the employment data store 222, the memory 216 or another information source for later access by the other components 204, 206, 208, 210, and 212 of the prospective candidate identification engine 106. The controller 202 may also provide the information associated with or parsed from a search request directly to the other components 204, 206, 208, 210 and 212 of the prospective candidate identification engine 106.

In some embodiments, the controller 202, in cooperation with the processor 214, may signal the employee identification module 206 to begin processing. For example, responsive to receiving and parsing the search request, the controller 202 may send an employee identification signal to the employee identification module 206 instructing it to identify the employees of the employer included in the search request. In some implementations, the controller 202 initiates and monitors the completion of some or all of the processing performed by each of the employee identification module 206, the candidate identification module 208, the ranking module 210, and/or the interface module 212. In other embodiments, the controller 202 simply initiates the processing and any handoffs between these components are managed by the components themselves. Various combinations of the forgoing embodiments where some of the processing is managed by the controller 202 and some is not are also contemplated and within the scope of the present disclosure. In yet other embodiments, after receiving and parsing the search request, the controller 202 may signal the interface module 212 to generate a summary of prospective employee candidates (as further discussed below) and the interface module 212 may initiate and monitor the processing by one or more of the components 202, 204, 206, 208, and 210, as required to generate and provide the summary to the user device 116 of the requestor/user 122.

The API module 204 is software including routines for interfacing with the social network server 102 to send and receive data to the social network application 104 and the social data store 108. In some embodiments, the API module 204 is a set of instructions executable by the processor 214 to provide this functionality. In other embodiments, the API module 204 is stored in the memory 216 of the social network server 102 and is accessible and executable by the processor 214 to provide this functionality. In any of these embodiments, the API module 204 is adapted for cooperation and communication with the processor 214 and the other components of the social network server 102.

The API module 204 may interface with the social network application 104 and/or the social data base 108 to request and receive information matching one or more criteria. In some embodiments, the API module 204 includes routines for accessing the functionality and data provided by the social network application 104 and the social data store 108. For example, the API module 204 may include routines for receiving a list of employees matching a given employer; receiving a list of contacts who are connected to a given employee or employees; receiving a social graph for a given user or a list of users; receiving profile information (e.g., personal and professional information) about a given user or list of users including, for instance, the content of their stream posts and their privacy setting on the social network; etc. Depending on the configuration, the API module 204 may be coupled to the social network application 104 to send and receive data. In implementations where an instance 106c of the prospective candidate identification engine 106 resides on the employer server 126 or the user device 116, the API module 204 can interface with the social network application 104 and the social data store via the network 112.

In some embodiments, the controller 202, the employee identification module 206, the candidate identification module 208, the ranking module 210, and the interface module 212 are coupled to the API Module 204 via the processor 214 to utilize its functionality. For example, the employee identification module 206 and the candidate identification module 208 can interact with the API module 204 to query for and receive information from the social network application 104 and/or the social data store 108, as discussed in further detail below.

The employee identification module 206 is software including routines for identifying one or more users as employees of one or more employers. In some embodiments, the employee identification module 206 is a set of instructions executable by the processor 214 to provide this functionality. In other embodiments, the employee identification module 206 is stored in the memory 216 of the social network server 102 and is accessible and executable by the processor 214 to provide this functionality. In any of these embodiments, the employee identification module 206 is adapted for cooperation and communication with the processor 214 and the other components of the social network server 102.

In some embodiments, the employee identification module 206 identifies the one or more users as employees responsive to receiving an employee identification signal from the controller 202 via the processor 214. The employee identification signal instructs the employee identification module 206 to identify the employees of one or more employers. To identify the user(s) as employee(s) of one or more employers, the employee identification module 206 may query an information source (e.g., the social data store 108) containing information associating users with their employers. In some embodiments, the employee identification module 206 may perform the query using the employer information (e.g., an employer's name) determined from the search request by the controller 202 and provided with the employee identification signal. In other embodiments, the employee identification module 206 may access the employer information from the employment data store 222, the memory 216, or another information source.

In some embodiments, the employee identification module 206 may identify the users as employees of an employer by querying the user profiles of the users of the social network. As previously discussed with reference to the social data store 108, a user profile for a given user may include the professional information for that user. In some embodiments, these user profiles are stored in the social data store 108, and the employee identification module 206 can interact with the API module 204 to query the social data store 108 for the employees of an employer. For example, the employee identification module may utilize a routine provided by the API module 204 to receive a summary of the employees that are employed by the one or more employers specified by or associated with a search request received by the controller 202. Alternatively, the employee identification module 206 may query the social data store 108 directly for a list/summary of users whose user profiles match the employer information. The list of users can include personal and professional information for each user, such as the user's name, title, a photograph, a geographic location or residence, résumé (e.g., short or long), etc.

In various embodiments, information about the employees of an employer, including data describing their social graphs and profiles may be stored in a local repository such as the employment data store 222, and the candidate identification module 208 may query the local repository for the prospective employee candidates. In these embodiments, the local repository may be periodically updated with up-to-date social graph and profile information for the users of the social network from the social data store 108, for example, by a batch job executed at periodic intervals (e.g., every few minutes, hourly, daily, etc.). In some embodiments, storage/replication of this information locally in a local repository is controlled by the privacy settings included in the user profiles of the users of the social network. While not depicted, in some embodiments, the prospective candidate identification engine 106 or the social network application 104 may include a task module for managing and executing the batch job. Information about who the employees of an employer are may also be stored in another information source, such as a data store included in the third-party server 136 or the employment server 126, and the employee identification module 206 may interact with the third-party server 136 or the employment server 126 via the network 112 to receive this information.

Once received, the employee identification module 206 may store information about the users/employees, such as the list/summary of the employees and professional information for each employee received by the employee identification module 206, etc., in the employment data store 222, the memory 216, or another information source for later access and retrieval by the other components 202, 204, 208, 210 and 212 of the prospective candidate identification engine 106, or may provide this information directly to one or more of these components for further processing.

The candidate identification module 208 is software including routines for identifying one or more users as prospective employee candidates via the connections of one or more employees identified by the employee identification module 206. In some embodiments, the candidate identification module 208 is a set of instructions executable by the processor 214 to provide this functionality. In other embodiments, the candidate identification module 208 is stored in the memory 216 of the social network server 102 and is accessible and executable by the processor 214 to provide this functionality. In any of these embodiments, the candidate identification module 208 is adapted for cooperation and communication with the processor 214 and the other components of the social network server 102.

In some embodiments, the candidate identification module 208 identifies the one or more prospective employee candidates responsive to receiving a candidate identification signal from the controller 202 or the employee identification module 206 via the processor 214. The candidate identification signal instructs the candidate identification module 208 to identify one or more users as prospective employee candidates. To identify the one or more prospective employee candidates, in some embodiments, the candidate identification module 208 may query the social graph(s), and in particular, the social graph connection information of the user(s) identified by the employee identification module 206 as employee(s) for any users that are connected to the employee(s). For instance, the social graph of a first user, who has been identified as an employee of an employer by the employee identification module 206, includes social graph connection information describing one or more social graph connections between the first user and the one or more second users, and the candidate identification module 208 identifies the one or more second users as prospective employee candidates based on the social graph connections between the first user and the one or more second users.

In some embodiments, the candidate identification module may query for prospective employee candidates using one or more employment criteria. For example, the controller 202 can determine an employment criterion based on the search request and the candidate identification module 208 may query the social graph(s) of the employee(s) using the employment criterion to limit the results to those that match it. The candidate identification module 208 may also retrieve social graph connection information (also referred to herein as social graph data) and profile data for the employee-connected users/prospective employee candidates it identifies. As discussed elsewhere herein, retrieving the social graph and profile data for the prospective employee candidates is beneficial as the information and data can be used to analyze and rank the candidates by the ranking module 210 and to describe the candidates in the summary generated by the interface module 212.

In some embodiments, the social graphs of the users (e.g., employees) of the social network are stored in the social data store 108, and the candidate identification module 208 queries the social data store 108 to identify the employee-connected users. In one example, the candidate identification module 208 may query the social data store 108 via the API module 204. For instance, the candidate identification module 208 may provide identifiers(s) (e.g., name(s), username(s), pointer(s), etc.) for the employee(s) identified by the employee identification module 206 to the API module 204, and the API module 204 may send a request to the social network application 104 and/or the social data store 108 for a list of users connected to the employee(s) and the social graph and profile data for those users. In another example, the candidate identification module 208 may interact directly with the social data store 108 and/or social network application 104 to receive this information.

In other embodiments, information about the users of the social network, including data describing their social graphs and profiles may be stored in a local repository, and the candidate identification module 208 may query the local repository to identify the prospective employee candidates. In these other embodiments, the local repository may be periodically updated with refreshed social graph and profile data for the users of the social network from the social data store 108 by a batch job executed at periodic intervals, as discussed above with reference to the employee identification module 206.

In some embodiments, prior to querying the social graphs, the candidate identification module 208 may send an employee ranking signal to the ranking module 210 via the processor 214 instructing the ranking module 210 to rank the employees identified by the employee identification module 206. In response to receiving the signal, the ranking module 210 may rank the employees based on one or more attributes attributable to the employees, including the strength of their connections to other professionals, experience, and skills. Additionally, the ranking module 210 may rank the employees using the ranking mechanisms further discussed below with reference to the ranking module 210. Once complete, the ranking module 210 may then provide data describing the ranking of the employees to the candidate identification module 208, either directly or by storing it, and the candidate identification module 208 may use the data to query for prospective employee candidates. To perform the ranking, in some embodiments the ranking module 210 may receive professional information for the employees directly from the employee identification module 206 or from an information source such as the employment data store 222, the memory 216, etc., and analyze this information to determine who the most senior, influential or prominent employees are. In some embodiments, the candidate identification module 208 may identify prospective employee candidates by searching the social graphs corresponding to a selection of the most influential employees as identified by the ranking module 210. This is advantageous as the employees who are more engaged or recognized in their professional community, or have substantial experience in their field, may be more connected in their respective social graphs to other individuals with similar attributes than employees who are lesser so. Moreover, using the top ranked employees to identify prospective employee candidates may produce a more reliable set of desirable prospective employee candidates by the candidate identification module 208.

Upon identifying the prospective employee candidates, the candidate identification module 208 may send a candidate ranking signal via the processor 214 to the ranking module 210 instructing the ranking module 210 to rank the prospective employee candidates, as further discussed below. The candidate identification module 208 may also store information about the prospective employee candidates, such as the list/summary of the prospective employee candidates, social graph and profile data for each candidate, information about one or more candidates retrieved from the search server 130, the employment server 126, and/or the third-party server 136, etc., in the employment data store 222, the memory 216, or another information source for later access and retrieval by the other components 202, 204, 206, 210 and 212 of the prospective candidate identification engine 106, or may provide this information directly to one or more of these components via the data bus 220 for further processing.

The ranking module 210 is software including routines for ranking the prospective employee candidates and/or the employees. In some embodiments, the ranking module 210 is a set of instructions executable by the processor 214 to provide this functionality. In other embodiments, the ranking module 210 is stored in the memory 216 of the social network server 102 and is accessible and executable by the processor 214 to provide this functionality. In any of these embodiments, the ranking module 210 is adapted for cooperation and communication with the processor 214 and other components of the social network server 102.

The ranking module 210 may be coupled to the candidate identification module 208 via the processor 214 to receive a candidate ranking signal. In some embodiments, the candidate ranking signal may instruct the ranking module 210 to rank prospective employee candidates identified by the candidate identification module 208. The ranking may be performed by the ranking module 210 based at least in part on one or more criteria. Criteria for ranking candidates may include attributes such as the number of professionals/users a candidate is connected with in his/her social graph; the number of employees/users a candidate is connected with in his/her social graph; the strength of a candidate's connections to any employees and professionals in his/her social graph; a candidate's employment history; a candidate's field of employment; a candidate's employment status; a candidate's current employer; a candidate's current title; an employment-related achievement by a candidate, an employment-related contribution by a candidate; a level of engagement of a candidate within his/her professional community, a level of experience the candidate has; a skillset the candidate has obtained; or any attribute included in the profile and/or employment history of the candidate.

In some embodiments, to perform the ranking, the ranking module 210 may statistically analyze each prospective employee candidates based on one or more of the above-noted ranking criteria and then rank the candidates based on the analysis. For example, the ranking module 210 may generate a score for each of the prospective employee candidates. The score could be a numerical expression of the statistical analysis of the candidate's attributes and may reflect the suitability of the candidate. For example, a higher numerical score may indicate a given candidate is better suited for employment than a lower one. The ranking module 210 could use the scores as the criterion for ranking the candidates.

Additionally or alternatively, the ranking module 210 can base the ranking of the prospective employee candidates on the one or more employment criteria. For example, if a particular position or skillset is being sought for by the search request, the ranking module may rank the prospective employee candidates based at least in part on how suited they are for the position or on the level of skill or experience they have obtained relative to the skillset. The ranking module may store ranking-related information in the employment data store 222, the memory 216, or another information source for later access and retrieval by the other components 202, 204, 206, 210 and 212 of the prospective candidate identification engine 106, or may provide this information directly to one or more of these components via the data bus 220 for use by these components.

The interface module 212 is software including routines for preparing and providing information to one or more of the other entities of the system 100 via the network 112. In some embodiments, the interface module 212 is a set of instructions executable by the processor 214 to provide this functionality. In other embodiments, the interface module 212 is stored in the memory 216 of the social network server 102 and is accessible and executable by the processor 214 to provide this functionality. In any of these embodiments, the interface module 212 is adapted for cooperation and communication with the processor 214 and the other components of the social network server 102. In some embodiments, the interface module 212 may generate the summary upon receiving a signal for it via the processor 214 from another component 202, 204, 206, 208, or 210 of the prospective candidate identification engine 202. In some embodiments, the signal may be received from the ranking module 210 after the prospective employee candidates have been ranked. In other embodiments, the signal may be received from the candidate identification module 208 or the controller 202.

Responsive to receiving the signal, the interface module 212 may generate a summary of the prospective employee candidates and provide the summary to a user device 116 of the user 122 requesting it. In some embodiments, the interface module 212 may generate a summary including the employee(s) identified by the employee identification module 206, the prospective employee candidate(s) identified by the candidate identification module 208, the ranking of the prospective employee candidates by the ranking module 210, and/or information about the employee(s) or prospective employee candidate(s) received from the employment server 126, the search server 130 and/or the third-party server 136, etc. The summary may include a graphical image of each employee and/or candidate, a biographical summary of each employee and/or candidate, a description of how each candidate is connected to the employee(s) of the employer, etc. The biographical summary may include the most pertinent professional-related aspects of the employee as specified by the ranking module 210, such as whether any given prospective employee candidate has worked for the employer previously, who the candidate is employed by, his or her title, etc. The interface module 212 may then send the account summary via the network 112 to the user device 116 of the user 122 who requested it.

In response to receiving the summary, the user application 118 may present the summary to a user 126 via one or more user interfaces. One example interface is described below with reference to at least FIG. 6. The summary sent by the interface module 212 may include presentational information and the user application 118 may use the presentational information to form the look and feel of the user interfaces. For example, the electronic file(s) or data stream(s) may be formatted using a markup language (e.g., HTML, XML, etc.), style sheets (e.g., CSS, XSL, etc.), graphics, and/or scripts (e.g., JavaScript, ActionScript, etc.), and the user application 118 may interpret the interface instructions and render an interactive Web User Interface (WUI) for display on a user device 116 based thereon. In other implementations, the user application 118 may determine the formatting and look and feel of the user interfaces independently. Using the user interfaces presented by the user application 118, the user can input commands selecting various use actions. For example, using these interfaces users transmit a request to view a complete professional profile for one or more employees or prospective employee candidates.

The interface module 212 may be coupled to the controller 202, the API module 204, the employee identification module 206, the candidate identification module 208, the ranking module 210, the social data store 108, and/or the employment data store 222 via the processor 214 to receive information generated by these components. In some implementations, the interface module 212 may retrieve information from the memory 216, the social data store 108, and/or the employment data store 222 for information that was prepared and stored by these components or is supplemental to information provided by these components.

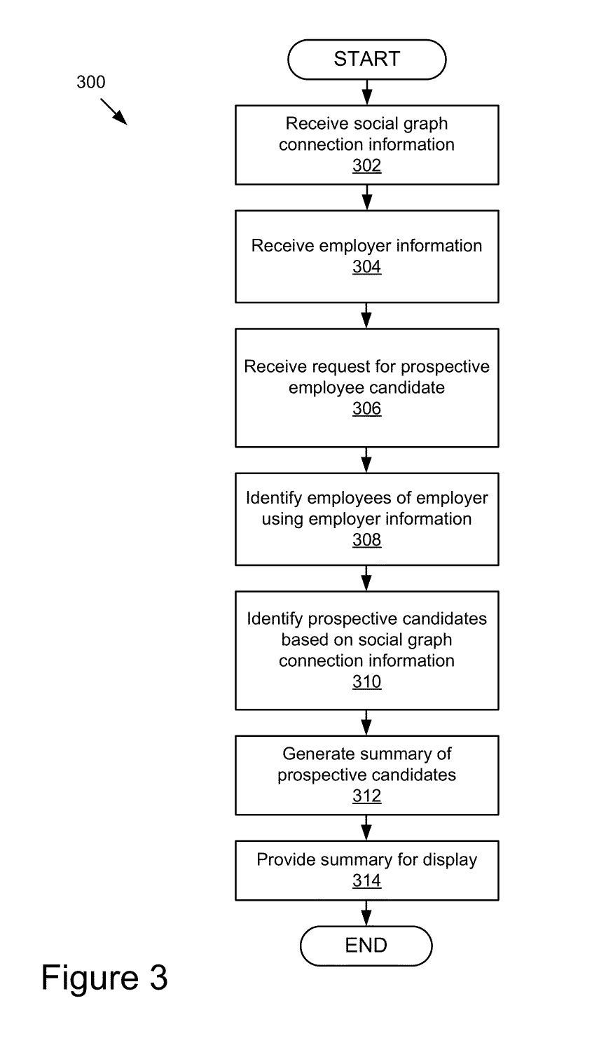

Additional structure and functionality of the controller 202, the API module 204, the employee identification module 206, the candidate identification module 208, the ranking module 210, the interface module 212, the social network application 104, the social data store 108, and the employment data store 222 are further discussed below with reference to at least FIGS. 3-6.

### Example Methods

Referring now to FIGS. 3-5B, various embodiments of the methods of the present disclosure are described. The various methods described use data in a social graph of a social network. Embodiments include appropriate data privacy protection measures. Further, numerous embodiments herein will be described without reference to the data privacy measures in place, but embodiments will nevertheless include such measures. FIG. 3 is a flowchart of an example method 300 for identifying prospective employee candidates via employee connections. The method 300 begins by receiving 302 social graph connection information. In some embodiments, the social graph connection information is received from users interacting with the social network and stored in an information source, such as the social data store 108. For instance, the social graph connection information may be received by virtue of a user explicitly adding other users as connections on the social network, arranging his/her connections on the social network into various groups, interacting with the social streams of other users, etc. In a further example, social graph connection information may be received by importing information from a third-party service that connects one or more users of the social network. Next, the method 300 receives 304 employer information describing an employer. The employer information may be a name or another identifier for an employer. In some embodiments, the employer information is received in association with the request received in block 306. In other embodiments, the employer information is received from another entity of the system 100, such as the social data store 108 or the controller 202. In these embodiments, employer information, such as information identifying users as employees of the employer, may also be received from these users for inclusion in their social network user profiles as professional information.

The method 300 continues by receiving 306 a request for one or more prospective employee candidates. In some embodiments, the method 300 may be initiated by receipt of a search request which includes the employer information identifying the employer. For example, a recruiter interesting in viewing what employees are connected to an employer can submit a search request that includes information describing the employer via a user interface displayed on the recruiter's user device 116, and the controller 202 may receive the request and parse it to determine the identity of the employer.

The method 300 continues by identifying 308 the employees of the employer using the employer information. In some embodiments, the method 300 may identify 308 the employees of the employer by querying an information store storing information associating one or more employees with the employer. For example, using the employer information, the method 300 may search the social data store 108 of the social network server 102 for users having profiles that identify them as employed by the employer. The results returned by the search may include data describing the employees along with their personal and/or professional information.

Next, the method 300 identifies 310 one or more users as prospective employee candidates based on the social graph connection information received in block 302. In some embodiments, the candidate identification module 206 identifies users as prospective employee candidates by querying the social graph of each user identified in block 310 as an employee for individuals who are connected to the employee/user. As discussed above, embodiments will include having appropriate data privacy measures in place to protect users' social graph data. For example, the candidate identification module 208 may query each employee's social graph via the API module 204. The results returned by the query may identify the individuals connected to the each employee in the social network along with personal, professional, and social graph information for each of the individuals. In some embodiments, these results may be refined by using one or more employment criteria.

The method 300 continues by generating 312 a summary of the users identified as prospective employee candidates in block 310. In some embodiments, the summary may include personal or professional information, such as information from each user's profile on the social network. For example, the summary may include a photograph, a short biographical description, information indicating how the candidate is connected to corresponding employee or employees, and a visual indication of the strength of the connection(s). For instance, if a candidate is connected to multiple employees of employer, those connections can be included in the summary for that candidate. The method 300 then provides 314 the summary for display to a user. It should be understood that, in some embodiments the processing in blocks 302-310 may be done automatically at periodic intervals, and processing in blocks 312 and 314 may be initiated in response to receiving a request for the summary. In other embodiments, the method 300 may be initiated by receiving a search request for identifying prospective employee candidates based on the connections of an employer's employees. Other variations of method 300 are also contemplated and fall within the scope of the present disclosure. The method 300 is then complete and ends.

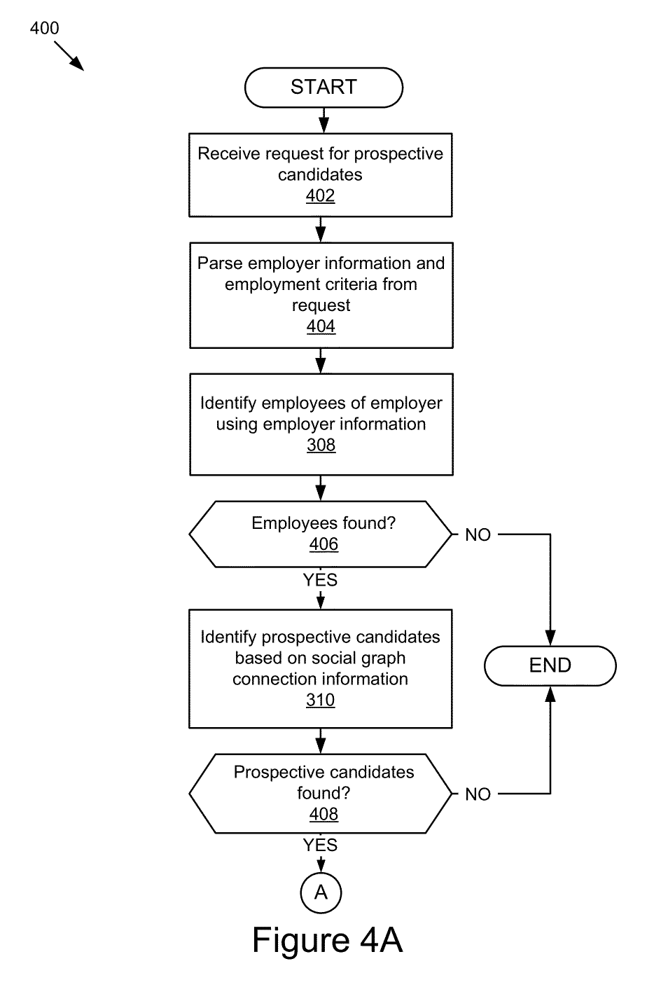

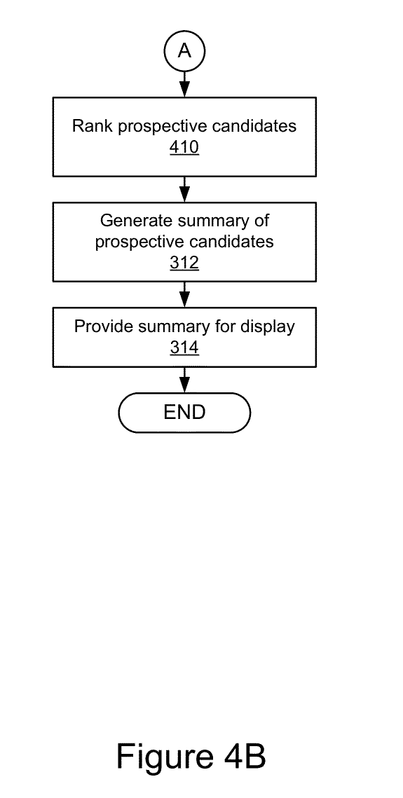

FIGS. 4A and 4B are flowcharts of another example method 400 for identifying prospective employee candidates via employee connections. As illustrated in FIG. 4, the method 400 includes blocks similar to or the same as those described above for the method 300. For convenience and ease of understanding, those blocks have the same reference numerals and perform the same or similar functions, and their description is incorporated by internal reference as indicated.

The method 400 begins by receiving 402 a request for a summary of prospective employee candidates, and parsing 404 the request for search parameters such as employer information and employment criteria. The employer information may specify the names/identifiers of one or more employers that should be used for the search. The employment criteria may specify one or more employment-related attributes that should be met by any prospective employee candidates. For example, the employment criteria may specify a field of employment, geographic region, etc.

The method 400 continues by performing the operations described by block 308 as discussed above with reference to at least FIG. 3. If it is determined 406 that no employees are identified in block 308, the method 400 ends. However, if one or more employees are identified in block 308, the method 400 continues by performing the operations described by block 310 as discussed above with reference to at least FIG. 3. If it is determined in block 408 that no prospective employee candidates were identified in block 310, the method 400 ends. However, if one or more prospective employee candidates were identified in block 310, the method 400 continues by ranking 410 the prospective employee candidates based on at least one criterion. In some embodiments, the prospective employee candidates may be ranked based on one or more criteria. For example, the ranking module 210 could rank the candidates based on the number or strength of their connections to the employees of the employer and/or other professionals within a particular profession. For instance, if a candidate is connected to multiple employees or to the contacts of the multiple employees, that candidate may be ranked higher than a candidate who is less connected. In another example, the ranking module 210 could rank the candidates using scores generated by the ranking module 210. Next, the method 400 performs the operations described by blocks 312 and 314 as discussed above with reference to FIG. 3. The method 400 then terminates.

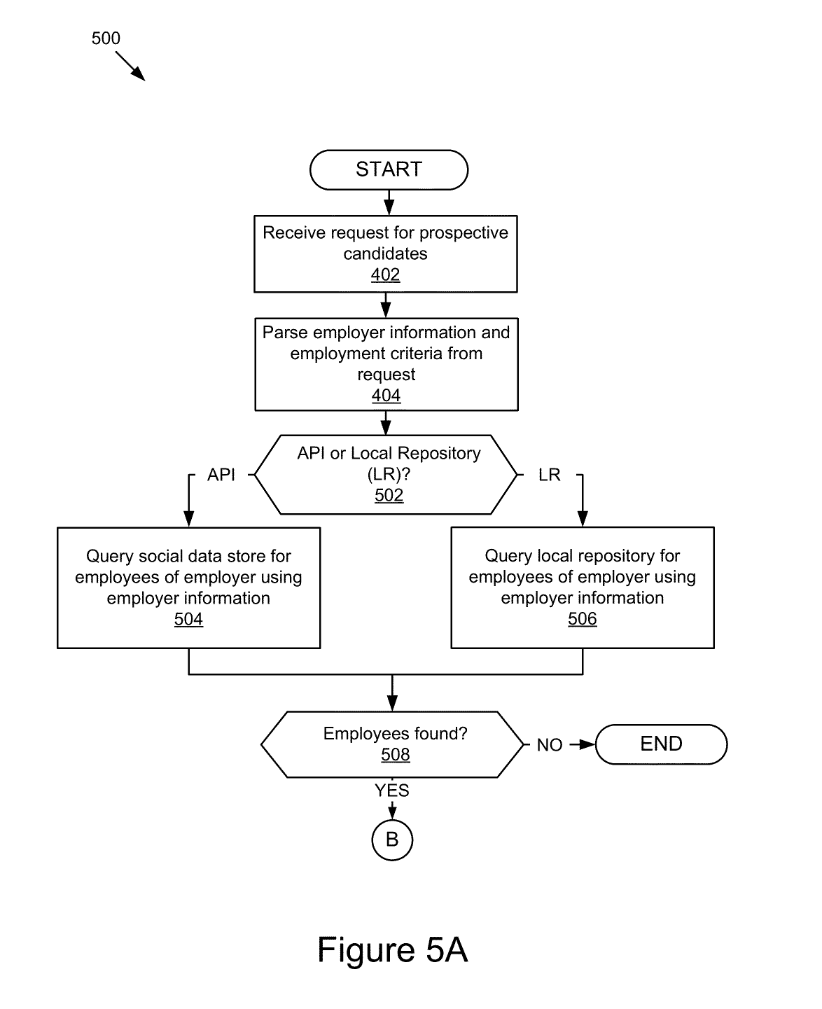

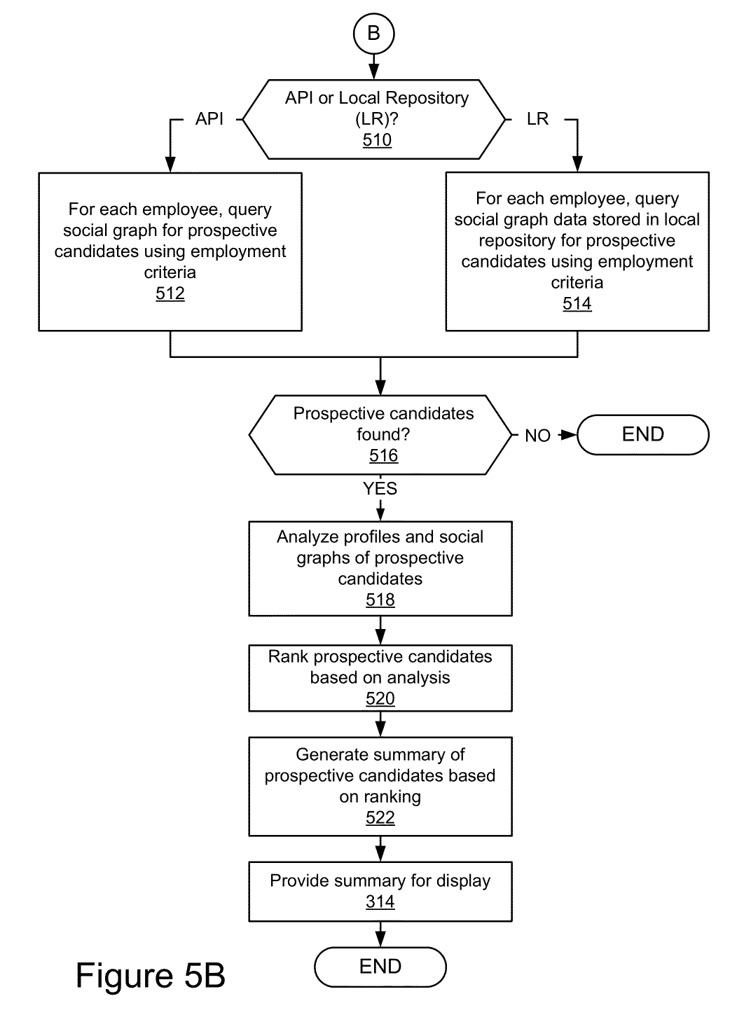

FIGS. 5A and 5B are flowcharts of yet another example method 500 for identifying prospective employee candidates via employee connections. As illustrated in FIG. 5A, the method 500 includes blocks similar to or the same as those described above for the methods 300 and 400. For convenience and ease of understanding, those blocks have the same reference numerals and perform the same or similar functions, and their description is incorporated by internal reference as indicated.

The method 500 begins by performing the operations described by blocks 402 and 404, as discussed above with reference to FIG. 4. Next, in block 502, the method determines whether to query the social data store 108 using an API, or a local repository directly for one or more employees of the employer. If the method 500 determines to search the social data store 108, the method 500 queries it via an API using the employer information. For example, to query the social data store 108 via the API, the employee identification module 206 interacts with the API module 204 as discussed above with reference to at least FIG. 2. If the method 500 determines to query a local repository, the method 500 queries it directly using employer information. The local repository may be the memory 216, the employment data store 222, or another information source. In some embodiments, the information stored in the local repository is retrieved from the social data store 108 by executing a batch job periodically.

If the method 500 determines in block 508 that no employees were identified in block 504 or block 506, method is complete and ends. In some embodiments, prior to completing, the method 500 may notify the user who submitted the request in block 402 that no employees were found. For example, interface module 212 may generate and send a notification for display to the user by the user application 118 informing the user that no employees were found based on the request, or may suggest a refined or expanded search that yields results including one or more employees.

If the method 500 determines in block 508 that one or more employees were identified in block 504 or block 506, the method 500 continues by determining 510 whether to query the social data store 108 via an API, or to query a local repository directly for one or more prospective employee candidates. If the method 500 determines 510 to query the social data store 108 via an API, then, the social graph of each employee, which is stored in the social data store 108, is queried 512 for prospective employee candidates using the one or more employment criteria parsed in block 404. For example, the candidate identification module 208 may interact with the API module 204 to query the social data store 108, as discussed above with reference to at least FIG. 2. If the method 500 determines 514 to query a local repository directly then, the social graph of each employee, which is stored in the local repository, is queried 514 for prospective employee candidates using the one or more employment criteria parsed in block 404. In some embodiments, the local repository may be the memory 216, the employment data store 222, or another information source. In some embodiments, information stored in the local repository is retrieved from the social data store 108 using periodic batch processing.

The method 500 continues by determining 516 whether any prospective candidates were identified in blocks 512 or 514. If no prospective candidates were identified, the method 500 is complete and ends. In some embodiments, prior to completing, the method 500 may notify the user who submitted the request in block 402 that no prospective employee candidates were found. For example, interface module 212 may generate and send a notification for display to the user by the user application 118 informing the user that no prospective employee candidates were found based on the request.

If one or more prospective employee candidates were identified in blocks 512 or 514, the method 500 continues by analyzing 518 a user profile and social graph of each prospective employee candidate and ranking the prospective employee candidates based on the analysis performed in block 518. In some embodiments, the ranking module 210 generates a score for each candidate reflecting the analysis and ranks the candidates based on the scores. Next, the method 500 generates 522 a summary of the one or more prospective employee candidates based on the ranking performed in block 520. The summary may include personal and professional information for each prospective employee candidate, which employees each prospective employee candidate is connected with, how they are connected, etc. Next, the method 500 provides 314 the summary for display to the user who submitted the request, as discussed above with reference to FIG. 3. The method 500 is then complete and ends.

It should be understood that the example methods 300-600 described above are provided by way of illustration and should not be interpreted as limiting. Moreover, it should be understood that numerous modifications of the sequence or make-up of the methods 300-500 are contemplated and fall within the scope of the present disclosure.

### User Interface

FIG. 6 is a graphic representation of an example user interface for displaying prospective employee candidates identified via employee connections. In the depicted embodiment, the user interface 600, which may be generated and displayed by the user application 118, includes a browser window including a menu bar 604, a sidebar region 606, and the content display region 612. The menu bar 604 includes selectors for navigating back to a search interface, setting or modifying user-configurable preferences, etc. The sidebar region 606 includes a navigation region 608 including electronic links (e.g., hyperlinks) to other associated content, and a tag region 610 which includes search criteria used to filter the prospective employee candidates displayed in the candidate region 616 of the content display region 612.

The tags included in the tag region 610 may include a cancel selector for canceling out the filtering effect of the tags. For example, upon canceling a tag/filter criterion, the prospective employee candidate results displayed in the candidate region 616 may be updated automatically to reflect the removal of the criterion. For instance, by selecting to cancel a tag, the user application 118 may send an updated request with updated employment criteria to the prospective candidate identification engine 106, and the prospective candidate identification engine 106 may process the request and provide an updated summary including a revised list of prospective employee candidates for display in the candidate region 616.

The content display region 612 also includes a job position region 614 for displaying a job for which the prospective employee candidates are being sought. In some embodiments, one or more of the attributes for the job displayed in the job position region 614 can be used by the candidate identification module 208 to filter the prospective employee candidates displayed in the candidate region 616. In some embodiments, the prospective employee candidates displayed in the candidate region 616 may be ranked by the ranking module 210 in order of who is best suited for or most closely matches the requirements for the position displayed in the content display region 612. For example, the first candidate, George Johnson, may have more experience in product management; may have more connections to the employees of ACME; etc., than Jill Clark or Jeff Anderson.

It should also be understood that the user interface 600 is provided by way of example and that many other user interfaces are also contemplated. For example, other user interfaces may include other information, elements, have a variety of distinct formats, positions within the window, and/or combinations, or may exclude various elements or information; all of which are encompassed by the scope of the present disclosure.

Various example embodiments for identifying prospective employee candidates via employee connections have been described. In the above description, for purposes of explanation, numerous specific details are set forth in order to provide a thorough understanding of the disclosure. It should be understood that the technology described in the various example embodiments can be practiced without these specific details. In other instances, structures and devices were shown in block diagram form in order to avoid obscuring the disclosure. For example, the present disclosure was described in some embodiments above with reference to user interfaces and particular hardware. However, the present disclosure applies to any type of computing device that can receive data and commands, and any devices providing services. Moreover, the present disclosure was described above primarily in the context of recruiting prospective employee candidates. However, it should be understood that the present disclosure applies to any type of association between users, professional or personal.

To ease description, some elements of the system 100 may be referred to using the labels first, second, third, etc. These labels are intended to help to distinguish the elements but do not necessarily imply any particular order or ranking unless indicated otherwise. Additionally, reference in the specification to “one embodiment,” “an embodiment” or “some embodiments” means that a particular feature, structure, or characteristic described in connection with the embodiment is included in at least one embodiment of the disclosure. The appearances of the phrase “in one embodiment” or “in some embodiments” in various places in the specification are not necessarily all referring to the same embodiment(s).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “ranking” or “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, wireless adapters, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps/blocks. The required structure for a variety of these systems will appear from the description above. In addition, the present disclosure is not described with reference to any particular programming language. It will be appreciated that a variety of programming languages may be used to implement the teachings of the disclosure as described herein.

It is intended that the scope of the disclosure be limited not by this detailed description, but rather by the claims of this application. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, it should be understood that the modules, routines, features, attributes, methodologies and other aspects of the disclosure can be implemented as software, hardware, firmware or any combination of the three. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way. Additionally, the disclosure is in no way limited to implementation in any specific programming language, or for any specific operating system or environment. Accordingly, the disclosure is intended to be illustrative, but not limiting, of the subject matter set forth in the following claims.

1. A computer-implemented method comprising:
receiving, using one or more computing devices, social graph connection information, wherein the social graph connection information includes at least a social graph connection between a first user and a second user;
receiving, using the one or more computing devices, employer information for an employer;
receiving, using the one or more computing devices, a request for a prospective employee candidate for the employer from a third user;
identifying, using the one or more computing devices, a plurality of employees of the employer based at least in part on the employer information, the plurality of employees including the first user;
determining, using the one or more computing devices, a prominence of the first user as an employee of the employer relative to other employees of the employer from the plurality;
identifying, using the one or more computing devices, the second user as a prospective employee candidate based at least in part on the social graph connection between the first user and the second user;
generating, using the one or more computing devices, a summary of the second user as the prospective employee candidate; and
providing the summary, using the one or more computing devices, for presentation to the third user.

2. The computer-implemented method of claim 1, wherein the request includes an employment criterion and the employer information, and the identifying the second user as the prospective employee candidate is further based at least in part on the employment criterion.

3. The computer-implemented method of claim 1, wherein the determining the prominence of the first user further includes:
ranking, using the one or more computing devices, the plurality of employees based on one or more of a strength of connections of the employees to other professionals, professional experience of the employees, and skills of the employees.

4. The computer-implemented method of claim 1, wherein the identifying the plurality of employees of the employer includes querying, using the one or more computing devices, an information source for user profiles that matches the employer information, the user profiles including professional information associated with the plurality of employees.

5. The computer-implemented method of claim 1, wherein the social graph connection information includes social graph connections between the first user and a plurality of second users, the identifying the second user as the prospective employee candidate includes identifying the plurality of second users as prospective employee candidates based at least in part on the social graph connections between the first user and the plurality of second users, and the summary is generated to include the plurality of second users as prospective employee candidates.

6. The computer-implemented method of claim 5, comprising:
ranking, using the one or more computing devices, the plurality of second users as prospective employee candidates based at least in part on a ranking criterion, wherein the summary is generated to reflect the ranking of the plurality of second users as prospective employee candidates.

7. The computer-implemented method of claim 6, comprising:
analyzing, using the one or more computing devices, one or more attributes associated with each user of the plurality of second users to generate a score for each user, wherein the ranking the plurality of second users as prospective employee candidates is based at least in part on the score for each user.

8. A computer program product comprising a non-transitory computer-usable medium including instructions which, when executed by a computer, cause the computer to:
receive social graph connection information, wherein the social graph connection information includes at least a social graph connection between a first user and a second user;
receive employer information for an employer;
receive a request for a prospective employee candidate for the employer from a third user;
identify a plurality of employees of the employer based at least in part on the employer information, the plurality of employees including the first user;
determine a prominence of the first user as an employee of the employer relative to other employees of the employer from the plurality;
identify the second user as a prospective employee candidate based at least in part on the social graph connection between the first user and the second user;
generate a summary of the second user as the prospective employee candidate; and
provide the summary for presentation to the third user.

9. The computer program product of claim 8, wherein the request includes an employment criterion and the employer information, and the second user is identified as the prospective employee candidate further based at least in part on the employment criterion.

10. The computer-implemented method of claim 8, wherein to determine the prominence of the first user further includes:
ranking the plurality of employees based on one or more of a strength of connections of the employees to other professionals, professional experience of the employees, and skills of the employees.

11. The computer program product of claim 8, wherein to identify the plurality of employees of the employer includes querying, using the one or more computing devices, an information source for user profiles that matches the employer information, the user profiles including professional information associated with the plurality of employees.

12. The computer program product of claim 8, wherein the social graph connection information includes social graph connections between the first user and a plurality of second users, to identify the second user as the prospective employee candidate includes identifying the plurality of second users as prospective employee candidates based at least in part on the social graph connections between the first user and the plurality of second users, and the summary is generated to include the plurality of second users as prospective employee candidates.

13. The computer program product of claim 12, wherein the instructions further cause the computer to:
rank the plurality of second users as prospective employee candidates based at least in part on a ranking criterion, wherein the summary is generated to reflect the ranking of the plurality of second users as prospective employee candidates.

14. The computer program product of claim 13, wherein the instructions further cause the computer to:
analyze one or more attributes associated with each user of the plurality of second users to generate a score for each user, wherein the plurality of second users are ranked as prospective employee candidates based at least in part on the score for each user.

15. A system comprising:
one or more processors, the processors being configured to:
receive social graph connection information, wherein the social graph connection information includes at least a social graph connection between a first user and a second user;
receive employer information for an employer;
receive a request for a prospective employee candidate for the employer from a third user;
identify a plurality of employees of the employer based at least in part on the employer information, the plurality of employees including the first user;
determine a prominence of the first user as an employee of the employer relative to other employees of the employer from the plurality;
identify the second user as a prospective employee candidate based at least in part on the social graph connection between the first user and the second user;
generate a summary of the second user as the prospective employee candidate; and
provide the summary for presentation to the third user.

16. The system of claim 15, wherein the request includes an employment criterion and the employer information, and the second user is identified as the prospective employee candidate further based at least in part on the employment criterion.

17. The system of claim 15, wherein to determine the prominence of the first user further includes:
ranking the plurality of employees based on one or more of a strength of connections of the employees to other professionals, professional experience of the employees, and skills of the employees.

18. The system of claim 15, wherein to identify the plurality of employees of the employer includes querying, using the one or more computing devices, an information source for user profiles that matches the employer information, the user profiles including professional information associated with the plurality of employees.

19. The system of claim 15, wherein the social graph connection information includes social graph connections between the first user and a plurality of second users, to identify the second user as the prospective employee candidate includes identifying the plurality of second users as prospective employee candidates based at least in part on the social graph connections between the first user and the plurality of second users, and the summary is generated to include the plurality of second users as prospective employee candidates.

20. The system of claim 19, wherein the one or more processors are further configured to:
rank the plurality of second users as prospective employee candidates based at least in part on a ranking criterion, wherein the summary is generated to reflect the ranking of the plurality of second users as prospective employee candidates.

21. The system of claim 20, wherein the one or more processors are further configured to:
analyze one or more attributes associated with each user of the plurality of second users to generate a score for each user, wherein the plurality of second users are ranked as prospective employee candidates based at least in part on the score for each user.
